(19) United States
(12) Patent Application Publication
(10) Pub. No.: US 2025/0354474 A1
(43) Pub. Date: Nov. 20, 2025

(54) METHOD AND SYSTEM FOR UTILIZING REAL-TIME DRILLING RIG DATA TO OPTIMIZE AND AUTOMATE DRILLING RIG OPERATIONS

(71) Applicant: Opla Energy Ltd., Calgary (CA)

(72) Inventors: Elvin Mammadov, Calgary (CA); Ahmad Alizadeh, Calgary (CA); Chen Guo, Calgary (CA)

(21) Appl. No.: 19/288,937

(22) Filed: Aug. 1, 2025

Related U.S. Application Data
(63) Continuation of application No. PCT/CA2023/050144, filed on Feb. 3, 2023.

(51) Int. Cl. E21B 44/00; E21B 21/08

(52) U.S. Cl. CPC E21B 44/00; E21B 21/08; E21B 2200/22

(57) ABSTRACT

A method and system of analyzing real-time drilling data to automate a drilling rig system for drilling a well. The method comprises: communicating, via a communication network, real-time data obtained from at least the drilling rig to a server to generate a data stream hosted on the server; monitoring, via a stream listener of an AI/ML software program hosted on a device, the data stream to detect an event; processing, via a processing engine of the AI/ML software, the real-time data relating to the detected event to generate processed data; inputting the processed data into an AI/ML module; generating, via the AI/ML module, an output, the output including a command to modify a drilling parameter of the drilling rig system; and implementing, via the output module of the AI/ML software, the command to modify the drilling parameter of the drilling rig system.

### CROSS-REFERENCE TO RELATED APPLICATIONS

This application is a continuation application under 35 U.S.C. § 111 (a) of International Application No. PCT/CA2023/050144 filed Feb. 3, 2023, the content of which is hereby incorporated by reference in its entirety.

### FIELD

The present disclosure relates to the operation of drilling rigs. In particular, the present disclosure relates to monitoring and analyzing real-time drilling data using machine learning and/or artificial intelligence models to monitor, control, optimize and/or automate the control of a drilling rig.

### BACKGROUND

Drilling rig operations for extracting resources from below the surface, including oil and gas resources, involves the implementation of a drilling rig and associated services, such as mud handling, processing and storing the extracted resources. A single drilling project typically requires numerous human operators or workers to conduct various tasks, both onsite and offsite. Onsite operators, including rig hands and engineers, perform tasks including manipulating the different components of the drilling rig, monitoring the drilling progress to detect any problems that may develop, and modifying drilling parameters to ensure safe and efficient drilling operations.

Various types of data, obtained from the well bore, the drilling rig and surrounding equipment, is typically captured and recorded to a database, which data may then be viewed onsite, and may also be viewed and analyzed offsite by engineers and technicians at a real-time operations center (RTOC), located remotely from the rig site. Where drilling operations are monitored at an RTOC, the operators at the RTOC may implement changes to the drilling parameters of the drilling rig by contacting the onsite operators and communicating the changes to be implemented.

Problems may arise during a drilling operation. Ideally, the development of such problems is detected early, and steps are taken to mitigate the problem to reduce or eliminate downtime for the drilling rig, drilling fluid losses, explosions and other incidents that may threaten the safety of onsite operators at the drilling rig. For example, not intended to be limiting, managed pressure drilling operations involve closed-loop drilling systems that are sealed, to control the bottomhole pressure of the well being drilled by manipulating the surface back pressure (SBP). The development of a well kick, involving the development of pressure fluctuations beneath the surface which may lead to formation fluids flowing back up the well bore, is an early warning sign that a blowout may occur. To prevent a blowout, drilling parameters may need to be modified in order to balance the hydrostatic pressure inside the well against the formation pressure. A kick may be identified through detecting anomalies in the drilling data. However, detecting such anomalies, interpreting the anomalies as indicators of a well kick or another drilling problem occurring, and then formulating actions that should be taken to prevent a blowout from occurring, often requires a worker to rely on years of drilling rig experience. Furthermore, because drilling operations are complex with multiple components and variables, it is often required to employ multiple workers, both onsite and offsite, to monitor the drilling data for problems that may develop. Because drilling rigs operate 24 hours per day, 7 days per week, continual monitoring is necessary, resulting in high labour costs.

Not all drilling rig workers will have the requisite drilling experience to ensure early detection of any developing problems. Furthermore, even an experienced drilling rig worker, such as an engineer, will have knowledge that is necessarily constrained to that individual worker's own experiences and training. Thus, if subtle changes or anomalies in the drilling data, which indicate a problem is developing, fall outside the experience and knowledge of the worker, it is possible that such anomalies will be missed. Furthermore, even workers with years of experience are capable of making mistakes and thereby missing anomalies occurring in the drilling data. The failure to timely recognize a developing problem on a drilling rig may lead to safety hazards, environmental hazards and/or economic losses.

In addition to monitoring for problems that may develop during a drilling operation, both onsite and offsite workers typically analyze drilling data to detect suboptimal drilling conditions and devise changes to drilling rig parameters to continue and optimize the drilling process. Regarding operation analysis, workers calculate engineering parameters based on existing models. The existing models are based on simplified physics formulas or correlations derived from empirical field data. However, such existing models introduce empirical coefficients which may restrict the universal applicability of the model, and so the model may only be valid in particular, specific drilling conditions. With respect to optimizing the engineering parameters to improve overall efficiency, modifying the engineering parameters to optimize the drilling rig system depends on the individual worker's experience, knowledge, and familiarity with different scenarios that may be presented. Thus, the extent to which the drilling system is capable of optimization is constrained by the collective knowledge and experience of the workers on a drilling project.

Optimizing the engineering parameters often involves setting some parameters at default values commonly used in the industry. Usually, the default values for such parameters are not re-analyzed and adjusted to account for the particular conditions of a given drilling project, which may result in sub-optimal performance of the drilling rig system. For example, when torque and drag analysis is conducted, the friction factor parameter is commonly set to default values known in the industry. Again, the use of default values may introduce errors in the analysis, if the default values used in the calculations differ from the actual friction factor values at the drilling site.

In the context of managed pressure drilling (MPD) operations, conventionally, the control system for MPD operations is located on the rig and requires an onsite human operator to monitor and operate the control system. Whether the rig is situated on land or water, any time an operator is onsite, there is a risk to the operator's safety. For the control system to operate, large amounts of data are collected from the various sensors in the MPD system in real-time for the control system's analysis and use. While conventional MPD systems, one of which is described in U.S. Pat. No. 10,113,408, may send such sensor data offsite for storage and subsequent analysis, the ability to monitor and control the MPD system in real-time is limited to the onsite control system, which is operated by a human operator at the well site.

The Applicant is aware that machine learning and/or artificial intelligence models (AI/ML models) may be applied to drilling rig data sets, in order to analyze the drilling rig operations and devise drilling parameter optimization. Typically, drilling rig data may be collected and recorded at the drilling site, and/or communicated, via a communications network such as the Internet, to a site that is remotely located from the drilling site. Such drilling rig data is often analyzed offsite, remotely from the drilling rig, and AI/ML models may be trained on this historical data in order to optimize aspects of the drilling rig system, at the same drilling site or at a new drilling site. Computer models, which may include but are not necessarily limited to AI/ML models, may be created based on analysis of historical drilling data sets to produce simulation models for engaging in well planning for a new or current drilling project. However, because such models are based on historical drilling data obtained from other drilling sites, the resulting predictions of engineering parameters may be sub-optimal, or may not be accurately applied, to a given drilling site where the drilling rig equipment, and/or drilling conditions, differ from the drilling rig equipment and/or drilling conditions that generated the historical drilling data sets.

In the Applicant's international publication no. WO/2022/204821, entitled “Internet of Things in Managed Pressure Drilling Operations,” the Applicant discloses a control system for a pressure management apparatus (PMA) of a drilling system. The control system includes an onsite device in close proximity to, and in communication with, the PMA, and an offsite device at a remote location. Both the onsite and offsite devices are connected to a network, such as the Internet, through which the devices may communicate with one another. The onsite device receives data in real-time from the PMA, and the offsite device may access the data in real-time via the network. The offsite device may generate a command, based on the data or user input, at the offsite device and send the command to the onsite device to modify one or more settings of the PMA. A control panel is displayed on the user interface of the offsite device to allow an operator to remotely control the PMA.

Accordingly, it is desirable to reduce the number of human operators required, onsite and offsite, to monitor, control and optimize a drilling operation. Reducing the number of human operators required onsite reduces the possibility of accidents and injuries that may otherwise occur to human operators working at a drilling site. Additionally, reducing the number of human operators, both onsite and offsite, will reduce the associated labour costs of a drilling project. Furthermore, there is a need to improve the monitoring of drilling operations to detect developing problems and take appropriate action, when problems are detected, to mitigate the impact on the drilling operations and reduce or eliminate incidents that may pose safety hazards to onsite workers and result in negative impacts to human life, the environment and economic losses. It is also desirable to improve the optimization of drilling parameters to increase the efficiency of drilling operations.

### SUMMARY

In one aspect of the present disclosure, the methods and systems disclosed herein employ AI/ML models, in combination with an internet of things control system, for the monitoring and analysis of real-time drilling data to control and manage drilling operations. Without intending to be limiting, one such internet of things control system is disclosed in the Applicant's international publication no. WO/2022/204821, which document is incorporated herein in its entirety. In some embodiments, the monitoring and analysis of real-time drilling data utilizing AI/ML models allows for improved accuracy in the early detection of developing problems, and the earlier deployment of actions to mitigate or prevent an incident from occurring. Actions may include, but are not limited to, instructions or commands to the control system to modify one or more drilling parameters, and/or notifying a group of personnel that action is required, which notification may include suggested modifications to one or more drilling parameters in the system.

In some embodiments, the monitoring and control of a drilling rig system utilizing the methods and systems disclosed herein may reduce the number of human operators required, onsite and offsite, to monitor and perform the drilling operations, by utilizing outputs of the AI/ML models to control, monitor and optimize the drilling rig system. In some embodiments, some aspects of controlling the drilling rig system may be partially or fully automated while increasing the overall efficiency and operation of the drilling rig system.

In some embodiments, the methods and systems disclosed herein are applied to MPD drilling operations to partially or fully automate the operation of a pressure management apparatus (PMA). Without intending to be limiting, the methods and systems herein may be deployed to partially or fully automate the control of a PMA that is disclosed in the Applicant's international publication no. WO 2021/142547, which document is incorporated herein in its entirety. In some embodiments, the systems and methods disclosed herein may be applied to monitoring the drilling data to detect when a rig pump has been stopped, which may occur for example upon connection of a segment of the drilling pipe. When a connection event is detected, the methods and systems herein may be applied to optimize and implement an overtrap table, which holds a target surface back pressure (SBP) during a rig pump shutdown, or during a connection event, by predicting how much pressure will be lost when the rig pumps are shutdown and increasing the target SBP to a higher value. Thus, when the rig pump goes off, and the hydrostatic pressure drops in the system, the pressure may drop to the target SBP. Advantageously, such systems and methods for maintaining target SBP during a rig pump shutdown reduce the costs, rig space requirements and operation times associated with the conventional utilization of auxiliary pumps to maintain the target SBP during rig pump shutdown. The overtrap table may be calculated and provided to a human operator for implementation, in some embodiments, whereas in other embodiments, the overtrap table may be automatically implemented by the control systems disclosed herein.

In another aspect, the systems and methods disclosed herein may be used to monitor and predict the maintenance requirements and failure points for equipment at the drilling site. As an illustrative example, the working conditions of each bearing assembly at a drilling site may be monitored by collecting data from a variety of sensors, for example, by measuring the SBP, rotational speed, total rotating time, total rotating distance, average and maximum rotational speed over time, etc. A large data set, indicating the performance of a plurality of bearing assemblies over time, may be constructed, including data about bearing failures, repairs, replacements and maintenance. An AI/ML model may be trained on the large data set in order to predict when a bearing may be approaching failure or require maintenance or replacement, based on monitoring the real-time data of the working conditions of that bearing. Such systems and methods are not intended to be limited to bearings and may include building AI/ML models for predicting failure, maintenance and replacement requirements for any type of drilling equipment, including but not limited to valves, chokes, actuators, motors and other drilling equipment.

In another aspect, the systems and methods disclosed herein may be used to monitor real-time data to identify an anomalous event that requires action. For example, not intended to be limiting, historical data sets associated with MPD drilling projects, associated with specific anomalous events, may be used to train AI/ML models in order to identify trends in the data that lead to the historical, anomalous event occurring. As an illustrative example, in the Applicant's experience it is known that if a sudden increase in the measured SBP occurs at the same time that a Flow Out spike is detected, and the chokes on the PMA swing open, there is a high probability of fluid influx from the formation into the wellbore. If such an event is detected early, it may be corrected by taking specific actions.

By training an AI/ML model on historical data sets in which fluid influx from the formation into the wellbore has occurred, the Applicant has found that the AI/ML model may then predict that such an event is about to occur by monitoring the real-time data on an MPD project. In addition to the trained AI/ML model being able to predict that fluid influx from the formation into the wellbore is highly probable when a sudden increase in the SBP occurs at the same time that a Flow Out spike is detected, the model may additionally identify other data trends that also predict fluid influx into the wellbore is highly probable. In some embodiments, the AI/ML model may also be fine-tuned to predict the severity of a detected anomalous event, thereby recommending an action that would best mitigate the specific anomalous event. Advantageously, in some embodiments the AI/ML model is frequently or continuously updated as it monitors the real-time data and processes of multiple drilling sites, with the data sets of each drilling site being accessed by the AI/ML model via a cloud-based platform. In one aspect, the autonomous AI/ML model is able to adapt to data drifts, dynamic events and massive data sets.

Drilling data to automate the control of a drilling rig is provided. The drilling rig and the AI/ML system are in communication with, and controllable by, a control system having a communication network. The communication network facilitates communication between and amongst at least an onsite device (the onsite device in communication with sensors and equipment of the drilling rig); an offsite device; and a server (the server hosting a data streaming platform for receiving real-time drilling data from the drilling rig via the onsite device). The server makes the real-time data available via the communication network as a data stream. The AI/ML system comprises an AI/ML software program, the AI/ML software program hosted on at least one of the offsite device, the onsite device and the server. The AI/ML software program comprises a stream listener module, which opens a stream listener of a plurality of stream listeners when the drilling rig commences operations. The stream listener obtains data relevant to a detected event from the data stream over the communication network, and the stream listener is in communication with a processing engine. The processing engine extracts and processes the relevant data obtained from the data stream and generates extracted data from the data stream. The AI/ML software program also comprises a machine learning (AI/ML) module in communication with the processing engine, the AI/ML module comprising at least one AI/ML model for analyzing the extracted data and generating an output, the output providing a command to modify the drilling rig system. The AI/ML software program also includes an output module in communication with the AI/ML module, the output module for enacting the outputting of the command received from the AI/ML module.

In some embodiments, the output module is a real-time notifier, and the command includes a real-time notification for alerting an identified personnel group of the detected event and the command to modify the drilling rig. In some embodiments, the output module is a real-time executor, and the command includes real-time, automated implementation of a modified drilling parameter applied to the drilling rig.

In another broad aspect of the present disclosure, a method of monitoring and analyzing real-time drilling data to automate a drilling rig system for drilling a well is provided. The method comprises communicating, via a communication network, real-time data obtained from at least the drilling rig to a server so as to generate a data stream hosted on the server; monitoring, via a stream listener of an AI/ML software program hosted on a device, the data stream so as to detect an event or condition; processing, via a processing engine of the AI/ML software program, the real-time data relating to the detected event or condition to generate processed data, the processed data provided as an input to an AI/ML module; generating, via the AI/ML module, an output, the output including a command to modify a drilling parameter of the drilling rig system based on an input of the processed data into the AI/ML module, the output provided to an output module of the AI/ML software program; and implementing, via the output module, the command to modify the drilling parameter of the drilling rig system.

In some embodiments, the processing step of the method includes filtering the real-time data to extract data that is relevant to the detected event or condition to exclude data that is irrelevant to the detected event or condition from the extracted data. In some embodiments, the method further includes a step of updating the AI/ML module with the processed data.

In some embodiments, the processing step includes filtering the real-time data to identify data relating to an anomalous event, and excluding the data relating to the anomalous event from the processed data that is used in the updating step to update the AI/ML module. In some embodiments, the processing step includes generating a visual representation of the filtered data relevant to the detected event or condition and outputting the visual representation to at least one of an offsite device and an onsite device for a worker to monitor the event. In some embodiments, the processing step includes transforming the extracted data into an accepted format for inputting the extracted data into the AI/ML module.

In some embodiments, the step of generating an output includes modifying the drilling parameter to optimize the drilling parameter. In some embodiments, the detected event is a well kick, and the generated output command includes notifying an identified personnel group of the detected well kick and recommending modifications to the drilling parameters to mitigate the consequences of a blowout.

In some embodiments, the detected event is a drill pipe connection, and the command to modify a drilling parameter of the drilling rig system includes generating an overtrap table, the overtrap table for increasing the surface back pressure (SBP) of the drilling rig system above a target SBP so that when the rig pump is turned off, the SBP will fall to the target SBP. In some embodiments, the implementing step includes the output module sending a notification to an identified personnel group via the communication network, the notification advising the identified personnel group of the detected drill pipe connection and including the generated overtrap table to be implemented by one or more individuals in the identified personnel group. In some embodiments, the implementing step includes the output module sending the command, via the communication network, to an onsite device, the onsite device to implement the parameters of the generated overtrap table via a controller of the drilling rig system.

In some embodiments of the method, the drilling rig system includes a pressure management apparatus, and the controller is a pressure management apparatus controller. In some embodiments, the event is a drilling anomaly and wherein the command generated by the AI/ML module includes a notification to be sent to an identified personnel group, alerting the identified personnel group of the drilling anomaly and providing a suggested action to mitigate the drilling anomaly. In some embodiments, the drilling anomaly is an influx of fluid into the wellbore, and the implementing step includes the output module sending the command, via the communication network, to an onsite device to stop a pump and close the well, via a controller of the drilling rig system, the controller in communication with the onsite device.

In some embodiments of the method, the monitoring step includes monitoring a status of an equipment unit of the drilling rig system, and detecting the event or condition includes detecting the equipment unit requires maintenance or repair, and the implementing step includes sending a notification to an identified personnel group that the equipment unit requires maintenance or repair. In some embodiments, the equipment unit comprises a plurality of equipment units monitored by a plurality of stream listeners to generate a processed data set, the processed data set containing data on the status of each equipment unit of the plurality of equipment units, and wherein the processed data set is input into the AI/ML module to generate an optimized maintenance schedule for each equipment unit of the plurality of equipment units. In some embodiments, the processed data set is generated from real-time data obtained for the plurality of equipment units deployed across a plurality of drilling rig systems.

### BRIEF DESCRIPTION OF THE FIGURES

FIG. 1A is a schematic view of a managed pressure drilling system having a control system according to one embodiment of the present disclosure.

FIG. 1B is a schematic view of an alternative managed pressure drilling system having the control system according to another embodiment of the present disclosure.

FIG. 1C is a schematic view of another managed pressure drilling system having the control system according to yet another embodiment of the present disclosure. FIGS. 1A to 1C may be collectively referred to herein as FIG. 1.

FIG. 2 is a schematic view of a pressure management apparatus of a managed pressure drilling system, according to one embodiment of the present disclosure.

FIG. 3A is a schematic view of the control system incorporating an AI/ML system, shown with its environment, according to one embodiment of the present disclosure.

FIG. 3B is a schematic view of the control system incorporating an AI/ML system, shown with its environment, according to another embodiment of the present disclosure.

FIG. 3C is a schematic view of the control system incorporating an AI/ML system, shown with its environment, according to yet another embodiment of the present disclosure.

FIG. 4 is a schematic view of the AI/ML program, according to an embodiment of the present disclosure.

FIG. 5 is an illustrative example of a trap table notification for a connection, according to an embodiment of the present disclosure.

FIG. 6 is an illustrative example of a visual display comprising a dashboard, according to an embodiment of the present disclosure.

### DETAILED DESCRIPTION

All terms not defined herein will be understood to have their common art-recognized meanings. To the extent that the following description is of a specific embodiment or a particular use, it is intended to be illustrative only and not limiting. The following description is intended to cover all alternatives, modifications and equivalents that are included in the scope, as defined in the appended claims.

The systems and methods herein employ AI/ML models, in combination with an internet of things control system, for the monitoring and analysis of real-time drilling data to control and manage drilling operations. Without intending to be limiting, an example of an internet of things control system is disclosed in the Applicant's international publication no. WO/2022/204821, which document is incorporated herein by reference. The monitoring and analysis may be performed in real-time or near real-time, both remotely from an offsite location via a network, such as the Internet, and onsite at the drilling rig.

### Overview of Equipment Utilized in Managed Pressure Drilling Operations

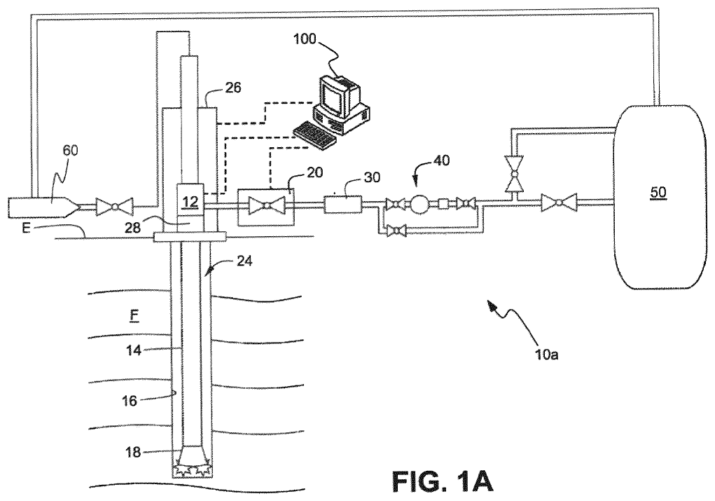

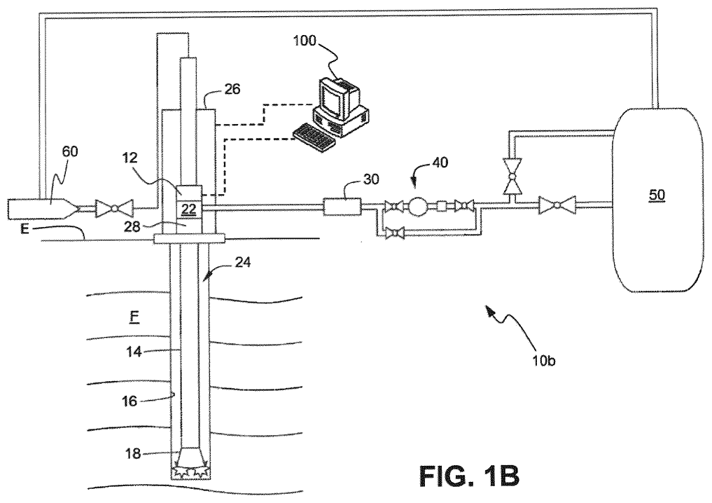

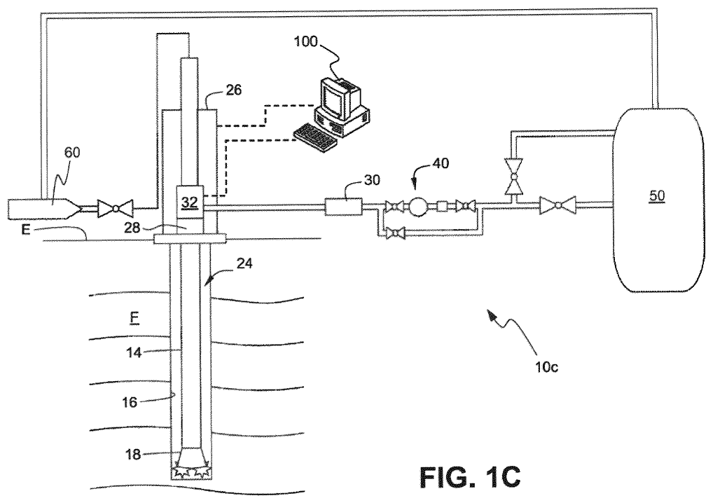

FIG. 1A illustrates an MPD system 10a for drilling a wellbore 16 through a formation F beneath the earth's surface E. The MPD system 10a comprises a rotating control device (RCD) 12 and a blowout preventer (BOP) stack 28, through which a drill string 14 sealingly extends. A portion of the drill string 14 extends downhole into the wellbore 16. The drill string 14 has a proximal end that is above surface E, above the RCD 12, and is coupled to a top drive (not shown) that is supported on a rig 26. The drill string 14 has a distal end that extends into the wellbore 16 and to which a drill bit 18 is affixed. A wellbore annulus 24 is defined between the outer surface of the drill string 14 and the inner surface of the wellbore 16. The system 10a also includes mud pumps 60, a standpipe (not shown), a mud tank (not shown), mud handling equipment 50, and various flow lines, as well as other conventional components such as a multi-phase flowmeter 30 and a gas evaluation device 40.

The RCD 12 may be a conventional RCD comprising a bearing assembly (not shown) having a sealing element and a bowl (not shown) for receiving the bearing assembly. The drill string 14 is slidingly run through the sealing element of the bearing assembly. The sealing element seals around the outside diameter of the drill string 14 and rotates with the drill string 14 while the drill string 14 rotates relative to the bowl during drilling operations.

The MPD system 10a further comprises a choke manifold 20 that is positioned between and operably coupled to the RCD 12 and the mud handling equipment 50 via flow lines. The choke manifold 20 is downstream from the RCD 12 and is upstream from the mud handling equipment 50. The choke manifold 20 is in fluid communication with the annulus 24 via the RCD 12 and operates to manage the pressure inside the wellbore 16 during drilling. In some embodiments, the manifold 20 has one or more chokes (not shown), a mass flowmeter (not shown), one or more pressure sensors (not shown), a controller (not shown) for controlling the operation of the manifold 20, and a hydraulic power unit (not shown) and/or electric motor (not shown) to actuate the chokes. The mass flowmeter may be a Coriolis type of flowmeter.

The mud handling equipment 50 may include variety of apparatus, including for example shale shakers, mud tanks, degassers, etc., and a skilled person in the art can appreciate that the specific apparatus to be used in equipment 50 may vary depending on drilling needs. The mud handling equipment is operably coupled to, and in fluid communication with, the mud pumps 60.

In operation, the MPD system 10a is used to control downhole pressure by manipulating surface applied pressure while the drill bit 18 extends the reach or penetration of the wellbore 16 into the formation F. To this end, the drill string 14 is rotated, and weight-on-bit is applied to the drill bit 18, thereby causing the drill bit 18 to rotate against the bottom of the wellbore 16. At the same time, the mud pumps 60 circulate drilling fluid to the drill bit 18, via the inner bore of the drill string 14. The drilling fluid is discharged from the drill bit 18 into the wellbore 16 to clear away drill cuttings from the drill bit 18. The drill cuttings are carried back to the surface E by the drilling fluid via the annulus 24. The drilling fluid and the drill cuttings, in combination, are also referred to herein as “drilling mud.”

From the annulus 24, the drilling mud flows into the RCD 12 and the RCD sends the drilling mud to the choke manifold 20 while isolating the well 16 from atmospheric conditions. The RCD 12 may include any suitable pressure containment device that keeps the wellbore 16 in a closed loop at all times while the wellbore is being drilled. The choke manifold 20 provides adjustable surface backpressure to the drilling mud to maintain a desired pressure profile within the wellbore 16. As the drilling mud flows through the choke manifold 20, the flowmeter of the choke manifold 20 measures returns flow and density. The drilling mud exiting the choke manifold 20 flows to the mud handling equipment 50, whereby the drilling fluid is separated from the drilling mud. The separated drilling fluid is then recirculated by the mud pumps 60 to the drill bit 18, via the drill string 14.

FIG. 1B shows an alternative MPD system 10b. MPD system 10b has the same components as MPD system 10a (FIG. 1A) except system 10b comprises a pressure management device (PMD) 22 in place of the choke manifold 20. In the illustrated embodiment, the PMD 22 is positioned at the wellhead, attached to the RCD 12 on top of the BOP stack 28, and is configured to receive fluid from the wellbore annulus 24 via the BOP stack 28 and RCD 12. Like manifold 20, the PMD 22 operates to exert adjustable backpressure on the wellbore 16. In some embodiments, the PMD 22 comprises one or more chokes (not shown), a flowmeter (not shown), one or more pressure sensors (not shown), one or more position sensors (not shown), a controller (not shown) for controlling the operation of the PMD 22, and one or more hydraulic power units (not shown) and/or electric motors (not shown) for operating the PMD 22. An example of PMD 22 is disclosed by the Applicant in PCT Patent Application No. PCT/CA2021/050042, which is incorporated herein by reference in its entirety. Drilling mud exiting the wellbore annulus 24 flows into the PMD 22 via the BOP stack 28 and, from the PMD 22, the drilling mud is sent to the mud handling equipment 50 for processing and recirculation as described above.

FIG. 1C shows another alternative MPD system 10c. MPD system 10c has the same components as MPD system 10a (FIG. 1A) except system 10c comprises an integrated pressure management device (IPMD) 32 in place of the RCD 12 and the choke manifold 20. In the illustrated embodiment, the IPMD 32 is connected to the BOP stack 28 at the wellhead and is configured to receive fluid from the wellbore annulus 24 via the BOP stack 28. The IPMD 32 is configured to perform the functions of both the RCD 12 and the choke manifold 20, i.e., applying backpressure on the wellbore 16 while sealing the wellbore 16 from the atmosphere. In some embodiments, the IPMD 32 comprises a bearing assembly (not shown), a bowl (not shown), one or more chokes (not shown), a flowmeter (not shown), one or more pressure sensors (not shown), one or more position sensors (not shown), a controller (not shown) for controlling the operation of the IPMD 32, and one or more hydraulic power units (not shown) and/or electric motors (not shown) for operating the IPMD 32. An example of IPMD 32 is also described in PCT Patent Application No. PCT/CA2021/050042. Drilling mud exiting the wellbore annulus 24 flows into the IPMD 32 via the BOP stack 28 and, from the IPMD 32, the drilling mud is sent to the mud handling equipment 50 for processing and recirculation as described above.

### Overview of the Internet of Things Control System

In particular, without intending to be limiting, the AI/ML systems and methods disclosed herein may be applied to the monitoring and control of managed pressure drilling (MPD) operations. Optionally, MPD systems may include a pressure management device (PMD) in place of a choke manifold. The PMD is positioned at the wellhead, attached to the rotation control device (RCD) on top of the blowout prevention (BOP) stack, and is configured to receive fluid from the wellbore annulus via the BOP stack and the RCD. Like a choke manifold, the PMD operates to exert adjustable backpressure on the wellbore; in some embodiments, the PMD comprises one or more chokes, a flowmeter, one or more pressure sensors, one or more position sensors, a controller and/or electric motors and actuators for operating the PMD. An example of a PMD is disclosed by the Applicant in PCT Patent Application No. PCT/CA2021/050042, which is incorporated herein by reference in its entirety. Although systems and methods disclosed herein may be deployed for the monitoring, control, operation and automation of MPD operations, including but not limited to MPD operations utilizing a PMD, it will be appreciated that the systems and methods disclosed herein are not limited to the control of MPD drilling operations and may, for example, be applied to non-MPD drilling operations, and to MPD drilling operations that do not utilize a PMD. In the present disclosure, each of the combinations of the RCD 12 and the choke manifold 20; the combinations of the RCD 12 and PMD 22; and the IPMD 32 may be referred to as a “pressure management apparatus” (PMA).

The control system for controlling a PMA in a drilling system of a drilling site comprises a controller and a plurality of components controllable by the controller. The control system also includes a network accessible via the Internet; an onsite device in communication with the controller and connected to the network, the onsite device configured to receive data from the controller and located at or near the drilling site; and an offsite device connected to the network and in communication with the onsite device via the network, the offsite device configured to receive the data from the onsite device via the network in real-time and to receive user input. The offsite device is located in a remote location from the drilling site and is configured to generate a command based on the data or the user input and send the command to the onsite device. The onsite device is configured to receive the command and send the command to the controller, causing the controller to modify at least one set of the plurality of components of the PMA. It is appreciated that the control system may be configured to control a plurality of drilling systems at a plurality of drilling sites; in such embodiments, at least one onsite device is located at each drilling site, and at least one offsite device, located remotely from the plurality of drilling sites, is in communication with each of the onsite devices via the network accessible via the internet.

According to another broad aspect of the present disclosure, there is provided a control system for a managed pressure drilling system having a drill string and a drill bit extended into a wellbore, an electric drilling recorder system, a mud pump, and a PMA in communication with an annulus defined between the drill string and the wellbore, the control system being in communication with the pressure management apparatus, the control system comprising: an onsite device in communication with a control unit of the pressure management apparatus and the electronic drilling recorder system to receive data in substantially real-time, the data being collected by a plurality of sensors of the pressure management apparatus and the electronic drilling recorder; and an offsite device comprising: a user interface having a display; a control panel accessible via the display; and one or more processors in communication with the onsite device via a communication network, the one or more processors having access to a first set of instructions that, when executed by at least one of the one or more processors, causes the offsite device to: generate, on the control panel, one or more of: a hole depth indicator showing a depth of the wellbore; a bit depth indicator showing a depth of the drill bit; a block height indicator showing a remaining length to a subsequent drill string segment connection; a flow in indicator showing a pump rate of a drilling fluid entering the wellbore; a flow out indicator showing a flow rate of a drilling mud entering the pressure management apparatus; a mud weight in indicator showing a mud weight of the drilling fluid entering the wellbore; a mud weight out indicator showing a mud weight of the drilling mud exiting the wellbore; a surface backpressure indicator showing a surface backpressure; a target surface backpressure indicator showing a target surface backpressure; an intermediate casing point (ICP) pressure indicator showing an ICP pressure; and an ICP equivalent circulating density (ECD) indicator showing an ICP ECD; iteratively update the control panel to display the one or more of the hole depth indicator, the bit depth indicator, the block height indicator, the flow in indicator, the flow out indicator, the mud weight in indicator, the mud weight out indicator, the surface backpressure indicator, the ICP pressure indicator, and the ICP ECD indicator in substantially real-time; and control the pressure management apparatus, via the onsite device, based at least in part on information displayed on the control panel.

### Overview-PMA Control Unit and Control System

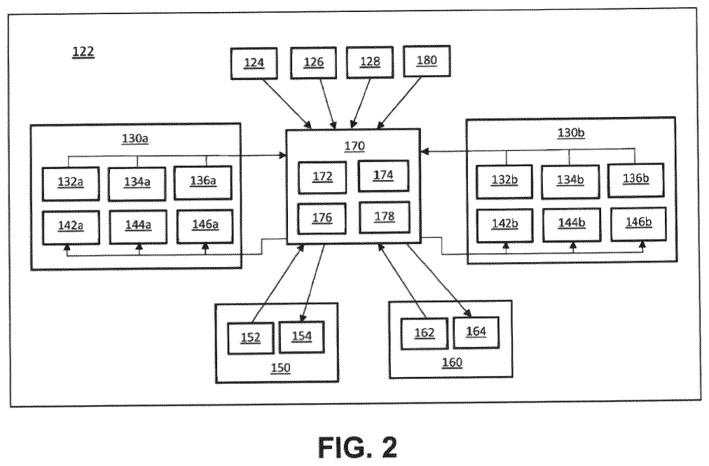

FIG. 2 shows an example of the components of the PMA 122. In some embodiments, the PMA 122 has a control unit 170. In some embodiments, the control unit 170 comprises a controller 172, a communication module 174, a motor drive module 176, and a radio remote control module 178. In some embodiments, the controller 172 may include a processor or other control circuitry configured to execute instructions or commands of a program that controls the operation of the PMA 122. The controller 172 may be a programmable logic controller (PLC) or any suitable controller known to those skilled in the art. In some embodiments, the controller 172 is configured to receive input from sensors and/or other components in the PMA 122 and control operations of one or more components of the PMA 122. In some embodiments, the controller 172 may use the communications format of WITS (Wellsite Information Transfer Specification) for a variety of data monitored and collected at the drilling site. In some embodiments, the controller 172 is configured to control the operation of one or more of the communication module 174, motor drive module 176, and radio remote control module 178. In some embodiments, the controller 172 is configured to execute commands that it receives from another device and/or commands that are based on pre-written code within the controller 172 to control the various below-described components of the PMA 122.

The communication module 174 is a communication device configured to exchange communications with another device via a wired or wireless connection. For example, the communication module 174 may be a wireless communication device configured to exchange communications over a wireless network. In some embodiments, the wireless communication device may include one or more of a GSM module, a radio modem, a cellular transmission module, or any type of module configured to exchange communications in one of the following formats: GSM or GPRS, CDMA, EDGE or EGPRS, EV-DO or EVDO, UMTS, or IP. In another example, the communication module 174 may be a wired communication device configured to exchange communications using a wired connection. In some embodiments, the communication module 174 may be a modem, a network interface card, or another type of network interface device. In some embodiments, the communication module 174 may be an Ethernet network card configured to enable the control unit 170 to communicate over a local area network and/or the Internet.

The motor drive module 176 is configured to communicate with the controller 172 and receive commands from the controller 172. The motor drive module 176 is operably coupled to, and in communication with one or more motors in the PMA 122 and, based on the commands received from the controller 172, the motor drive module 176 operates to drive one or more motors.

The radio remote control module 178 is configured to communicate with the controller 172 and receive commands from the controller 172. In some embodiments, the radio remote control module 178 receives commands from the controller 172 via radio signals. The radio remote control module 178 is configured to wirelessly communicate with one or more mechanical devices (not shown), such as a joystick coupled to an actuator, for moving a part of the PMA 122 relative to another part of the PMA. For example, an actuator may be used to move the bearing assembly relative to the bowl of the PMA 122 and the movement of the actuator is controlled by a joystick, which may be manually operated by the operator or remotely operated by the radio remote control module 178 via radio signals. Based on commands from the controller 172, the radio remote control module 178 can actuate the joystick to move the bearing assembly relative to the bowl.

In some embodiments, the PMA 122 has a plurality of data collection devices, which may include one or more of: a pressure sensor, a temperature sensor, a position sensor, a flowmeter etc. In some embodiments, the PMA 122 comprises a pressure sensor 124, a temperature sensor 126, and a flowmeter 128, which may be located at or near an inlet (not shown) of the PMA 122 for measuring the pressure, the temperature, the flow rate of the fluid entering the PMA 122. The pressure sensor 124, the temperature sensor 126, and the flowmeter 128 may be in communication with the control unit 170 by wired (e.g., Ethernet, USB, etc.) or wireless (e.g., Wi-Fi, Bluetooth®, etc.) connection and may be configured to transmit data to the control unit 170.

In some embodiments, the PMA 122 has one or more chokes 130a, 130b. Each choke 130a, 130b may have a respective choke position sensor 132a, 132b for determining the position of the choke trim relative to the choke orifice of the choke. The closer the choke trim is to the choke orifice, the more “closed” the choke is. A choke is fully closed if substantially no fluid can flow therethrough. Likewise, the farther away the choke trim is from the choke orifice, the more “open” the choke is. In some embodiments, the openness of a choke may be indicated by a percentage value, with 100% being fully open and 0% being fully closed. In the illustrated embodiment, each choke 130a, 130b of the PMA 122 has a respective choke motor 142a, 142b for driving an actuator (not shown) of the choke to change the position of the choke trim relative to the choke orifice of the choke, to make the choke more open or more closed.

In some embodiments, a respective choke valve position sensor 134a, 134b is associated with each choke 130a, 130b for determining whether the choke is “online” or “offline”. A choke is online if it is in fluid communication with the wellbore annulus 24. A choke is offline if it is not in fluid communication with the wellbore annulus 24. Each choke 130a, 130b may comprise a respective choke valve motor 144a, 144b for driving an actuator (not shown) to render the choke online or on offline.

In some embodiments, one or more of the chokes 130a, 130b may be a cartridge-style type of choke, as described in PCT Patent Application No. PCT/CA2021/050042, wherein the choke comprises a choke housing and a choke cartridge removably received in the choke housing. In these embodiments, the choke 130a, 130b may have a respective choke cartridge position sensor 136a, 136b for determining the position of the choke cartridge relative to the choke housing, i.e., whether the choke cartridge is fully installed in the choke housing. When the choke cartridge is fully installed in the choke housing, the choke cartridge may be referred to as “inserted”. When the choke cartridge is removed from the choke housing, the choke cartridge may be referred to as “removed”. Where the choke 130a, 130b is a cartridge-style type of choke, the choke may comprise choke cartridge motor 146a, 146b for driving an actuator (not shown) to move the choke cartridge relative to the choke housing.

The choke position sensors 132a, 132b, the choke valve position sensors 134a, 134b, and the choke cartridge position sensors 136a, 136b may be in communication with the control unit 170 by wired or wireless connection and are configured to transmit data to the control unit 170. The choke motor 142a, 142b, the choke valve motor 144a, 144b, and the choke cartridge motor 146a, 146b may be in communication with the control unit 170 by wired or wireless connection and are configured to be driven by the motor drive module 176.

The PMA 122 may have a flowline valve 150 that controls fluid flow in a choke gut line (not shown) of the PMA 122. In some embodiments, if the choke gut line is open, fluid entering the PMA 122 flows through the choke gut line while bypassing the chokes 130a, 130b and exits the PMA 122. If the choke gut line is closed, fluid entering the PMA 122 flows through one or more of the chokes 130a, 130b and then exits the PMA 122. In some embodiments, the PMA 122 has a flowline valve position sensor 152 for determining whether the choke gut line is open or closed. The flowline valve position sensor 152 may be in communication with the control unit 170 by wired or wireless connection and is configured to transmit data to the control unit 170. In some embodiments, the PMA 122 has a flowline valve motor 154 for driving an actuator (not shown) to change the position of the flowline valve 150 for opening and closing the choke gut line. The flowline valve motor 154 may be in communication with the control unit 170 by wired or wireless connection and is configured to be driven by the motor drive module 176.

In some embodiments, the PMA 122 comprises an RCD module 160 having a bearing assembly (not shown) and a bowl (not shown) for receiving the bearing assembly. In some embodiments, the RCD module 160 comprises at least one position sensor 162 for determining the position of the bearing assembly relative to the bowl, i.e., whether the bearing assembly is attached to the bowl. The position sensor 162 may be in communication with the control unit 170 by wired or wireless connection and may be configured to transmit data to the control unit 170. In some embodiments, the RCD module 160 has a latching motor 164 for driving an actuator (not shown) to move the bearing assembly relative to the bowl, for the purposes of securing the bearing assembly to the bowl and releasing the bearing assembly from the bowl. The latching motor 164 may be in communication with the control unit 170 by wired or wireless connection and may be configured to be driven by the motor drive module 176. In some embodiments, the bearing assembly may be rotationally secured to the bowl, as described by the Applicant in U.S. Provisional Patent Application No. 63/115,720, which is incorporated herein by reference in its entirety.

In some embodiments, the PMA 122 comprises a digital camera 180 or other types of optical sensing device for capturing images and/or videos of the PMA 122. In some embodiments, the camera 180 is used for capturing images and/or videos of the RCD module 160, to help determine the position of the bearing assembly relative to the bowl. The camera 180 may be in communication with the control unit 170 by wired or wireless connection and may be configured to transmit data to the control unit 170. In some embodiments, the bearing assembly and/or the bowl may have visual indicators on the outer surface that can be easily captured by the camera 180 for facilitating the determination of the relative positions of the bearing assembly and the bowl.

It can be appreciated that other embodiments of the PMA 122 may comprise only some of the above-mentioned components. In alternative embodiments, instead of motors, the PMA may comprise other drive mechanisms, such as hydraulic power units, pneumatic power units, etc., for actuating one or more actuators (not shown) in the PMA. Each of the above-mentioned sensors, flowmeter 128, and camera 180 of the PMA may continuously transmit data to the control unit 170, periodically transmit data to the control unit 170, or transmit data to the control unit 170 in response to a change in previously collected data.

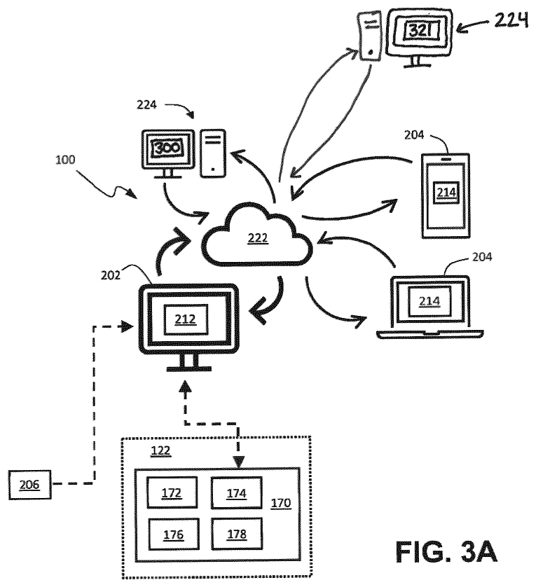

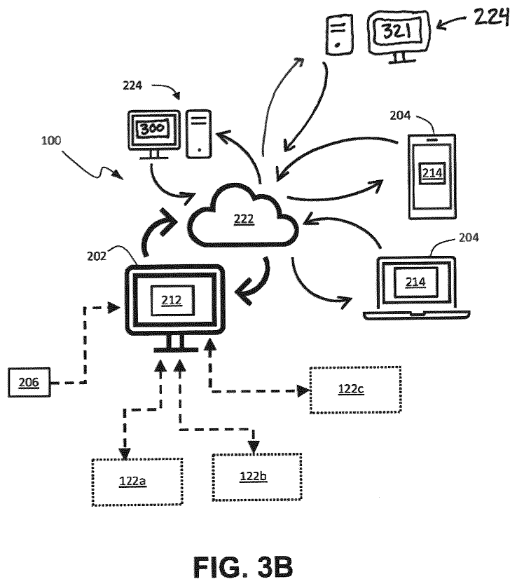

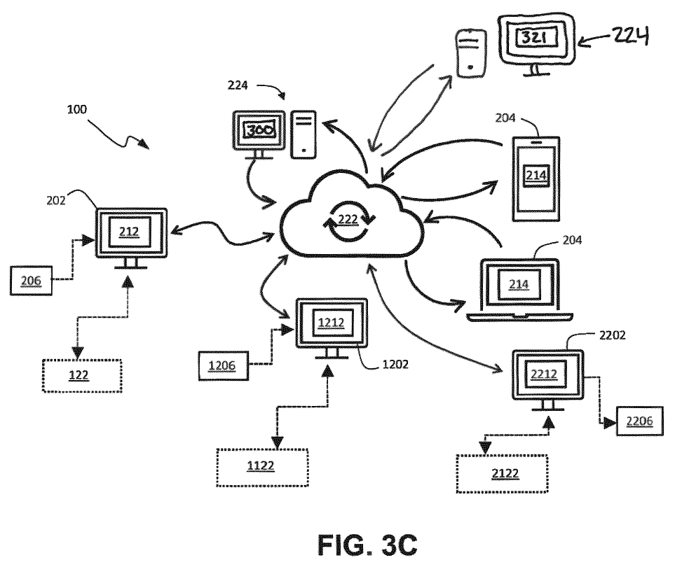

FIG. 3A shows a sample configuration of the control system 100 in its environment. In the illustrated embodiment, the control system 100 is configured to allow an operator (also referred to as “user”) to monitor and control the PMA 122 of a drilling system (e.g., MPD system 10a, 10b, 10c of FIG. 1) from an onsite location and an offsite location. While the control system 100 is described herein in relation to the monitoring and control of a PMA, it can be appreciated that the control system 100 may be configured to monitor and control other or additional components of the drilling system.

The system 100 comprises at least onsite communication device 202 and at least one offsite communication device 204, both connected to and in communication with an interactive communication network 222. Also connected to network 222 are one or more server computers 224, which store information and make the information available to the onsite and offsite devices 202,204. The network 222 allows communication between and among the onsite device 202, the offsite device 204, and the servers 224. The network 222 may be a collection of interconnected public and/or private networks that are linked together by a set of standard protocols to form a distributed network. While network 222 is intended to refer to what is now commonly referred to as the Internet, it is also intended to encompass variations which may be made in the future, including changes and additions to existing standard protocols. It may also include various networks that connect mobile and wireless devices, such as cellular networks. When servers 224 are physically remote from users of the onsite and offsite devices 202, 204, but are accessible to those users via network 222, the servers 224 are sometimes referred to herein as being “in the cloud.” In some embodiments, the network 222 and servers 224 are part of a virtual private cloud (VPC). Servers 224 may use a variety of operating systems and software optimized for the distribution of content via networks. The network 222 may include one or more networks that have wireless data channels. In some embodiments, the network 222 is configured to host data streaming platforms, such as for example Apache Kafka©, and/or database management services, such as for example Apache Cassandra©, to support the operation of system 100.

The onsite device 202 and offsite devices 204 may connect to the network 222 via a broadband connection such as a digital subscriber line (DSL), cellular radio, or other forms of broadband connection to the Internet. In some embodiment, the onsite device 202 and/or the offsite devices 204 can access the network 222 via an Internet service, such as a web browser or an application on the device, which establishes a communication link with the network 222. The offsite device 204 may receive data from the onsite device 202 via network 222 or the servers 224 may relay data received from the onsite device 202 to the offsite device 204 through the network 222. In some embodiments, the servers 224 may facilitate communication between the onsite device 202 and the offsite device 204.

The onsite communication device 202 is located at the drilling site, in close physical proximity to the control unit 170 of the PMA 122. The onsite device 202 may comprise one or more processors and may be equipped with communications hardware such as a modem or a network interface card. One or more processors may be, for example, general-purpose processors, multi-chip processors, embedded processors, etc. In some embodiments, the onsite device 202 has a user interface and hosts one or more software programs and/or applications. The user interface may comprise one or more of: a keyboard, a mouse, a touchpad, a display, a touch screen, audio speakers, and a printer. In some embodiments, the onsite device 202 can receive user input via the user interface. The onsite device 202 may comprise a storage medium, which may include one or more of: random access memory (RAM), electronically erasable programmable read-only memory (EEPROM), read-only memory (ROM), hard disk, floppy disk, CD-ROM, optical memory, or other mechanisms for storing data.

The onsite device 202 may be operably coupled to and in communication with the control unit 170 of the PMA 122. The onsite device 202 may be wired (e.g., Ethernet) or wirelessly connected to the control unit 170 in, for example, a local communication network (e.g., local area network (LAN)) at the drilling site. In some embodiments, the onsite device 202 may also be in communication with an electronic drilling recorder (EDR) system 206 of the drilling system. The EDR system is in communication with a variety of sensors that are located on the rig and collects data from the sensors. The onsite device 202 may be wired or wirelessly coupled to the EDR system 206 in, for example, a local communication network at the drilling site.

In some embodiments, the onsite device 202 is configured to host software programs and/or applications for managing the PMA 122 (“PMA software 212”). In some embodiments, the onsite device 202 may operate the PMA software 212 locally or within a local network at the drilling site. The PMA software 212 can access data collected by the sensors and flowmeter of the PMA 122 via the control unit 170. The PMA software 212 can also send electronic communications (e.g., commands, data, etc.) to the control unit 170 to cause the control unit 170 to change one or more settings of the PMA 122. When the onsite device 202 is connected to the EDR system 206, the PMA software 212 can access the data of the sensors on the rig. In some embodiments, the PMA software 212 can send communications (e.g., data) to the EDR system. The data provided to the PMA software 212 by the control unit 170 and the EDR system may be direct data captured by the sensors and flowmeter or may be processed prior be being received by the PMA software 212.

In some embodiments, the PMA software 212 can send and receive communications to and from the network 222. In some embodiments, the PMA software 212 is configured to communicate with and control aspects of the PMA 122 via the control unit 170 and to communicate with the offsite devices 204 via network 222. In additional or alternative embodiments, at least some of the PMA software 212 may be stored on the servers 224. In some embodiments, the servers 224 may receive data from the PMA software 212, store the received data, and perform analyses on the received data. Based on the analyses, the servers 224 may send communications to one or both onsite device 202 and offsite devices 204.

In some embodiments, with reference to FIGS. 1 and 3, by exchanging communications with the control unit 170 and, optionally, the EDR system 206, the PMA software 212 of the onsite device 202 is configured to allow an operator to monitor and control the PMA 122 during a drilling operation, which may include one or more of, e.g., drilling of the wellbore 16, the connection of the drill string 14, tripping out of the drill string 14, circulation of fluid in the wellbore 16, reaming of the wellbore 16, handling of a kick or a loss while drilling the wellbore 16, and any offline operation. In some embodiments, the PMA software 212 provides a platform for monitoring all the sensors in the PMA 122 (and optionally the sensors of the EDR system) and for controlling the settings of various components in the PMA 122. In some embodiments, the onsite device 202 can store the data collected from the control unit 170 and, optionally, the EDR system. In some embodiments, the PMA software 212 can receive user input from the operator via the user interface to adjust one or more settings of the PMA 122. Upon receipt of the user input, the PMA software 212 generates an appropriate command and sends the command to the control unit 170. Where a command is generated by the PMA software 212 based on user input, the command is referred to as “manually obtained.”

In some embodiments, based at least in part on the collected data, the PMA software 212 can perform various analyses on the operational parameters of the drilling system and accordingly send commands to the control unit 170 of the PMA 122 to obtain the desired parameters for the drilling operation. Where a command is generated by the PMA software 212 based on the analysis performed by the PMA software 212, the command is referred to as “self-generated”. Commands for the PMA 122 can thus be obtained manually or self-generated by the PMA software 212 with an automated sequence of actions. Whether manually obtained or self-generated, the commands may be sent by the PMA software 212 to the control unit 170 to adjust the settings of the PMA 122 to, for example, manage the wellbore pressure during drilling. In one example, the PMA software 212 may signal the control unit 170 to change the position of one or both chokes 130a and 130b.

In some embodiments, the PMA software 212 may include pre-set rules that dictate acceptable values for the monitored variables, for example, acceptable ranges. In some embodiments, the pre-set rules may be generated by the PMA software 212 based on its own analysis. In additional or alternative embodiments, the pre-set rules are based on user input and/or can be modified by user input. In some embodiments, based on the data provided by the control unit 170, if the PMA software 212 determines that any of the pre-set rules is broken, the PMA software 212 may prompt the operator for user input by sending out an alert, such as a pop-up box in the display of the onsite device 202, a text or email message to the operator, or other methods known to those in the art. In alternative or additional embodiments, upon determining that a pre-set rule has been broken, the PMA software may send a self-generated command to the control unit 170 to correct the problem.

In some embodiments, the PMA software 212 may employ real-time hydraulics, Torque and Drag (T&D), and/or Wellbore Stability (WBS) models. In some embodiments, the PMA software 212 provides real-time analysis and future drilling event predictions. By monitoring data provided by the control unit 170 and optionally the EDR system 206, the PMA software 212 may predict future drilling problems and events before they manifest themselves. For example, the PMA software 212 may provide real-time hydraulics analyses and control using algorithms that include the effects of temperature and pressure on downhole fluid hydraulics.

With reference to FIGS. 2 and 3, in some embodiments, based on the data provided by the control unit 170 of the PMA 122 and the EDR system 206, the PMA software 212 of the onsite device 202 can monitor the flow rate of fluids entering the PMA 122 (measured by flowmeter 128), the injection pressure (or standpipe pressure) provided by the EDR system 206, the surface backpressure (measured by the pressure sensor 124), the position of the chokes 130a, 130b (determined by position sensors 132a, 132b), and the mud density of the drilling fluid (measured by the flowmeter 128). By monitoring for any deviations in these variables, the PMA software 212 can identify fluid influxes into the wellbore from the formation and losses of drilling mud into the formation in real-time. Upon detecting such influxes or losses, the PMA software 212 can automatically send the necessary commands to the control unit 170 to control or correct the influxes or losses or may prompt the operator of the onsite device 202 for specific user input by sending an alert.

In some embodiments, by monitoring for deviations in the above-mentioned variables, the PMA software 212 can detect choke plugging or other choke failures. Upon detecting such failures, the PMA software 212 can automatically send commands to the control unit 170 to mitigate against such failures or may prompt the operator for user input. For example, the PMA software 212 may send a command, whether manually obtained or self-generated, to the control unit 170 to place the failed choke offline and put the other choke online so that fluid can be redirected to the other choke. For example, if choke 130a is online and choke 130b is offline, but the PMA software 212 detects a failure in choke 130a, then the PMA software sends a command to the control unit 170 to cause the motor drive module 176 to drive choke valve motor 144a to place choke 130a offline (i.e., blocking fluid flow thereto) and to drive choke valve motor 144b to put choke 130b online, so that fluid entering the PMA 122 is redirected to choke 130b.

In some embodiments, by monitoring the signals of the choke position sensors 132a, 132b and the choke valve position sensors 134a, 134b, the PMA software 212 can determine which choke(s) is online and how open the online choke(s) is. When the PMA software 212 (or the operator of the onsite device 202) determines that it is necessary to change the choke setting, the PMA can send a command to the control unit 170 to cause the motor drive module 176 to drive one or more of the choke motors 142a, 142b and the choke valve motors 144a, 144b. In one example, to open choke 130a further, the PMA software 212 sends a command to the control unit 170 to cause the motor drive module 176 to drive choke motor 142a. In another example, to redirect fluid from one choke 130a to another choke 130b, the PMA software 212 sends a command to the control unit 170 to cause the motor drive module 176 to drive both choke valve motors 144a, 144b, with the motor 144a placing choke 130a offline while the motor 144b puts choke 130b online.

Before drilling begins, the bearing assembly is first secured to the bowl of the RCD module 160. In some embodiments, the PMA software 212 can facilitate the process of securing the bearing assembly to the bowl by monitoring the signal of the position sensor 162 and, optionally, images or footage captured by the camera 180 to determine whether the bearing assembly is secured to the bowl. For example, upon determining that the bearing assembly is not yet secured to the bowl, the PMA software 212 may send a command to the control unit 170 to cause the motor drive module 176 to drive the latching motor 164 to move the bearing assembly relative to the bowl.

While the illustrated embodiment in FIG. 3A shows one onsite device 202 in communication with one PMA 122 and one or more offsite devices 204 in communication with the onsite device 202 via the network 222, it can be appreciated that other configurations are possible. For example, as shown in FIG. 3B, the onsite device 202 may be in communication with multiple PMAs 122a, 122b, 122c at the same drilling site, and the PMA software 212 of the onsite device 202 is configured to enable the user to monitor and control one or more of the multiple PMAs simultaneously. The PMA application 214 of the offsite device 204 is configured to communicate with the onsite device 202 via the network 222 as described above, thus allowing the user of the offsite device to monitor and control all the PMAs 122a, 122b, 122c as well. PMAs 122a, 122b, 122c may each be the same as or similar to PMA 122 described above. In this embodiment, the control panel of the offsite device 204 may be configured to show data of all the PMAs 122a, 122b, 122c simultaneously or allow the user to select which PMA's data to display. The user may thus monitor and control one or more of the PMAs 122a, 122b, 122c remotely via the control panel of the offsite device 204.

In another example, as shown in FIG. 3C, there are multiple onsite devices 202, 1202, 2202, each being located at a respective drilling site and having a respective PMA software 212, 1212, 2212 installed thereon. PMA software 1212, 2212 may be the same as or similar to PMA software 212 described above. Each onsite device 202, 1202, 2202 is in communication with a respective PMA 122, 1122, 2122 at the respective drilling sites. PMAs 1122, 2122 may each be the same as or similar to PMA 122 described above. In some embodiments, each onsite device 202, 1202, 2202 is in communication with a respective EDR system 206, 1206, 2206 at each drilling site. The PMA application 214 of the offsite device is configured to communicate with each of the onsite devices 202, 1202, 2202 via the network 222, thus allowing the user of the offsite device 204 to monitor and control all the PMAs 122, 1122, 2122 across the multiple drilling sites simultaneously. In this embodiment, the control panel or dashboard of the offsite device 204 may be configured to show data of all the PMAs 122, 1122, 2122 simultaneously or allow the user to select which drilling site's data to display. The user may thus remotely monitor and control one or more of the PMAs 122, 1122, 2122 at the different drilling sites via the control panel of the offsite device 204.

### Machine Learning/Artificial Intelligence Systems and Methods

The control system, described above, further includes an integrated artificial intelligence/machine learning system (AI/ML system), which utilizes machine learning and/or artificial intelligence models to monitor and analyze drilling data, including but not limited to PMA data and electronic drilling recorder (EDR) data, to perform different functions at the drilling rig site. In one aspect, as illustrated in each of FIGS. 3A, 3B and 3C, the AI/ML system 300 may be implemented on a server 224, which is connected to the communication network 222. The AI/ML system 300 accesses historical drilling data sets from a database 321, the database 321 being hosted on the same server 224 or on a separate server 224 that is also connected to the communication network 222. Additionally, the AI/ML system 300 accesses real-time drilling data from a drilling site, which real-time drilling data may be provided by a combination of the EDR 206, the PMA software 212 loaded onto an onsite communication device 202, and/or any other data obtained from one or more onsite communication devices 202 that may collect data from other drilling rig equipment. Additionally, the AI/ML software 300 communicates with specified users, who may include drilling rig workers and drilling engineers, to send alerts and messages to the specified users regarding the drilling rig operations. The alerts and messages, herein also referred to as notifications, may notify the specified users of a detected anomaly in the drilling system, a pending equipment failure, a recommended action that should be taken, the operating status of the drilling system, and any other information that the specified group of users may need to know about the drilling operations at a given drilling site.

Additionally, in some embodiments the AI/ML system may be configured to automate the control of the drilling system, such as by implementing changes or improvements to the drilling rig equipment itself, including a PMA in cases of MPD drilling operations. For example, the AI/ML software 300 is in communication with the PMA software 212 via the communication network 222. The AI/ML software 300 may therefore generate a command, based on the AI/ML software's monitoring and analyzing the real-time data obtained from the drilling system, and that command may be delivered to the PMA software 212 via the communication network 222. The PMA software 212, residing on an onsite communication device 202, may implement the command by communicating with the control unit 170 of the PMA 122, for example in order to control the choke motors to manipulate the SBP, in response to a detected connection of the drilling pipe or in order to optimize aspects of the drilling operations. Although the PMA control unit 170 is provided here as an example, it will be understood that control units for other drilling equipment may also be provided and controlled in a similar manner.

In conventional MPD operations, field and RTOC engineers will monitor real-time drilling data to confirm that drilling operations are proceeding as expected. Certain data trends may indicate to an experienced engineer or technician that an abnormal event, such as a kick or a loss, is occurring or may be imminent. Typically, it is preferable to recognize such indications of an abnormal event as early as possible and to take action by modifying different drilling parameters in order to mitigate the abnormal event and prevent consequences that may otherwise occur, such as a blowout. However, the ability of a particular engineer to detect an abnormal event, based on real-time data, and then act quickly enough to prevent the consequences of the abnormal event, depends on the engineer's skills, knowledge, and experience in the field. The failure of a human engineer to timely recognize an abnormal event and then take appropriate action may lead to catastrophic losses, which may include loss of human life, destruction of the drilling rig equipment, and uncontrolled release of contaminants into the environment.

Advantageously, the AI/ML systems and methods disclosed herein may be used to monitor and analyze the real-time drilling data, in order to detect abnormal events and take appropriate action, in a shorter period of time than an experienced engineer is capable of doing. The AI/ML software is configured, in some embodiments, to perform monitoring of drilling operations, event detection and anomaly detection. In a preferred embodiment, the AI/ML software constantly monitors the real-time data, provided to the AI/ML software 300 via the communication network 222, and analyzes the real-time data to generate control commands to modify one or more aspects of the drilling system, based on data that was extracted from a data stream and analyzed by the AI/ML software 300.

As will be further discussed below, the AI/ML models of the systems and methods disclosed herein may be trained on large, historical data sets, such that the AI/ML models will recognize data trends that lead up to prior abnormal events and catastrophic consequences, and also to recognize the appropriate actions that should be taken to mitigate or prevent the consequences from occurring. In addition, in some embodiments the AI/ML models may be periodically or continually updated, by analyzing the real-time data obtained from one or more drilling operations, in order to refine the model's ability to recognize and react to, abnormal events when they occur. In addition to training the AI/ML models to recognize data trends that indicate an abnormal event is occurring, based on the collective experience of field and RTOC engineers obtained from previous drilling operations, the AI/ML models may also be trained to recognize the contribution of other, more subtle data trends in the drilling data that additionally indicate an abnormal event is occurring, even when such subtle data trends have not been previously recognized by a human engineer. Typically, the subtle data trends are often early signs of an equipment failure, and once an AI/ML model has been trained to recognize such subtle data trends, this may lead to the earlier detection, and resolution of, developing equipment failures, which may lead to the significant reduction of downtime and the subsequent reduction in operation and maintenance costs.

In addition to detecting and mitigating abnormal events and equipment failure, the AI/ML models may be configured to improve operation calculations and analysis. Conventionally, the existing formulas and models for calculating engineering parameters are primarily based on equations developed through simplified physics formulas or correlations based on empirical data collected from the field. Such models and formulas introduce several empirical coefficients, which tend to restrict the universal applicability of the models and formulas, so that they may only be valid for specified drilling conditions. However, the AI/ML models may be trained and configured to analyze large data sets obtained from the field, on a particular drilling site, and identify patterns and relationships between the various engineering parameters and their effects on one another and the overall drilling operation. Therefore, the models may, in some embodiments, yield more accurate predictions as compared to using traditional operation calculations and models, because the inputs to these calculations are more accurately calibrated to the particular drilling environment for a given drilling site.

With respect to adjusting drilling parameters to optimize the process, conventionally, such optimization changes are performed by operators or engineers, relying on their experience and familiarity with different scenarios to improve the drilling system's performance. However, such an approach to optimization, again, relies on the collective experience of the engineers and operators of a drilling rig and therefore is necessarily constrained to the extent of the training and experience of the human engineers who are contributing to the optimization process. Advantageously, the AI/ML models may be trained on large, historical drilling data sets to learn how to control and optimize the process, and as such, the AI/ML models may beneficially provide improved optimization and control of the process by analyzing more data than a group of human engineers would be able to analyze over several years of experience.

Similarly, when it comes to parameters optimization, conventionally there are some parameters related to the operation that are set to default values. Typically, re-analysis of the effect of those parameters, set at the default values, and their subsequent impact on the operations, does not occur over time. Therefore, the system may be operating under sub-optimal parameters, presenting an opportunity for fine-tuning the system to optimize the system. As an example, when torque and drag calculations are performed, there is a friction factor parameter that is commonly set at a default value commonly accepted in the industry. Whereas, the systems and methods described herein may be configured to calculate torque and drag, based on real-time data obtained from the well, and a more precise value for the friction factor parameter may be determined and applied. Because the more precise value for the friction factor parameter, used in the torque and drag calculations for a particular well, is based on real-time data obtained from that well, the resulting calculations may result in more accurate engineering and monitoring of the process. Advantageously, using parameters derived from real-time data obtained from a drilling site, as compared to using typical industry values, may significantly improve the performance of sensitive operations such as MPD operations, in which the wells have a narrow drilling window and may be easily damaged if calculated engineering parameters used to control and monitor the process are inaccurate.

The methods and systems disclosed herein may also be used to monitor equipment performance, in order to predict maintenance needs or impending equipment failure, thereby allowing an operator to efficiently maintain and repair equipment before equipment failure occurs. This may lead to lower costs as a result of reducing rig downtime and efficiently planning for maintenance and repair requirements. By predicting that equipment maintenance or repair is required before failure occurs, an operator may be able to have the correct equipment and personnel in place, thereby further reducing the costs associated with extended downtime that may occur when an unexpected equipment breakdown occurs, and the downtime is extended while the appropriate parts and repair personnel are delivered to the site.

As described above, various improvements to the drilling operations are obtained by applying the AI/ML systems and methods disclosed herein. Combining together these different improvements may, in some embodiments, provide for a semi-automated or fully automated control system for drilling operations, including but not limited to MPD operations. Working together with the control systems described above, the AI/ML systems and methods may be applied to monitor the processes, recognize data trends indicating an abnormal event is occurring, devise actions required to respond to the detected abnormal event, and then execute commands to control the software and/or the hardware components of the system. As well, the AI/ML systems and methods disclosed herein may improve the ability of the engineers and managers to monitor and control the system, by sending notifications to appropriate personnel groups to alert them to a detected event and provide a suggested course of action. In some embodiments, the system may be configured to monitor the drilling operations, analyze the relevant data and then notify the human engineers of the detected events and suggest a course of action, which action is then implemented by the human engineer. However, the Applicant notes that as the AI/ML models are trained with larger and larger data sets, and the actions suggested by the AI/ML models are validated over time by the human engineers, in some embodiments the AI/ML models may be employed to automate the control of some, or all fully, aspects of the drilling operations. In the different embodiments described herein, regardless of whether the systems and methods are used to fully or partially automate the drilling operations, the embodiments may lead to improved operational efficiency, improved safety of the human workers on the drilling site, reduce production costs and/or minimize environmental impact.

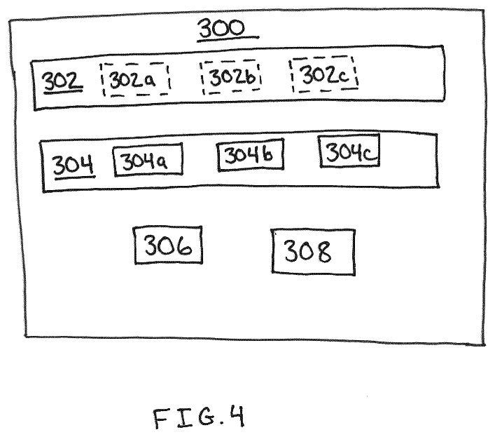

Referring to FIG. 4, in some embodiments the AI/ML software 300 comprises a stream listener module 302, a processing engine 304, an AI/ML module 306 and an output module 308. Each of these components is described in more detail below, and following these descriptions, three illustrative examples of specific applications of the methods and systems disclosed herein are provided so as to explain how the disclosed systems and methods may be employed in the context of an MPD operation. However, it will be appreciated that the following illustrative examples are not intended to be limiting in any way and are merely provided for the purpose of illustrating how the AI/ML software may be configured to control or optimize different aspects of the drilling operations.

### Stream Listener Module

The stream listener module 302 is configured to initiate a plurality of stream listeners. The stream listener module is scalable and may be configured to simultaneously accommodate any number of tasks that are running in the field, across one or more drilling operations that are connected to the control system. In one aspect, the stream listener module 302 is configured to automatically open a stream listener 302a, 302b, 302c, etc. when a new task is initiated, and close the stream listener when the task is completed, to release the system resources and make them available for other tasks.

Each stream listener 302a, 302b, 302c, when opened by the stream listener module 302, connects to the relevant database and communication channels for a given drilling operation and listens to, or in other words, monitors, the real-time data stream, which may be obtained from a data streaming platform hosted on the network 222. The stream listener 302a, 302b, 302c also opens the relevant communication channels to send notifications to the identified personnel group, so that the specific human engineers and workers will receive notifications about the task they are assigned to monitor and control. The stream listener also communicates the relevant data, obtained from the data stream, to the associated processing engine 304. When a task is completed, the stream listener (302a, 302b or 302c, etc.) and associated communication channels will be automatically closed by the stream listener module 302, making the system resources available for monitoring other tasks.

### Processing Engine

The processing engine 304 receives the relevant data stream from the stream listener (302a, 302b, 302c, etc.) for an identified task. The processing engine 304 is configured to process the ongoing data stream, and in some embodiments, has three main components: a filter 304a, a transformer 304b and a plotter 304c.

The filter 304a filters the large volume, high-velocity data obtained from the data stream and extracts the data that is relevant to the identified task. The purpose of the filter is to identify and extract only the data from the data stream that is relevant to the identified task. The extracted data is communicated to the transformer 304b.

The transformer 304b cleans and transforms the raw, extracted data, to provide it in a format that is accepted by the AI/ML module 306. Additionally, the transformed, extracted data is stored in a database, for additional uses such as training new AI/ML models or updating other, existing AI/ML models.

The plotter 304c generates visual representations of the extracted data, which visual representations may be presented to a human engineer or worker on an onsite device 202 or an offsite device 204, in the form of graphs, charts, plots, icons and the like. Multiple visual representations of the data, tracking various different parameters, may be provided on a single screen or dashboard, which provides a human user of the system with an overview of the real-time data in a format that is easier for the human to understand. This allows for human workers to remotely monitor a detected event or task, in real-time, and may provide for better decision-making by the human workers, working in conjunction with the automated and semi-automated controls of the AI/ML system.

The AI/ML software may be configured to perform various monitoring, optimization and/or control tasks for a given drilling operation. Each monitoring, optimization and/or control task requires a specific processing engine 304 that is configured for extracting and processing the data that is relevant to that particular task. As such, the AI/ML software 300 may typically include a plurality of processing engines 304, each processing engine 304 configured for extracting and processing the data for a particular task.

### AI/ML Module

The AI/ML module 306 utilizes AI/ML models to analyze and interpret the extracted and transformed, real-time data obtained from the data stream that is relevant to the identified task or event. The AI/ML module may be configured to produce outputs, depending on the requirements. For example, in some embodiments the AI/ML module may generate predictions and recommended actions, for example, to mitigate an impending blowout or repair a piece of equipment before it fails. In other embodiments, the AI/ML module may generate commands that are implemented through the control system to make adjustments to various parameters in the drilling system, for example by opening or closing chokes in a PMA. Adjustments to the parameters of the drilling system may optimize the drilling system, thereby improving the efficiency of the drilling operation, in addition to mitigating predicted drilling problems or equipment failure. Any combination of the outputs described above may be implemented by the AI/ML module.

As described above in relation to the processing engines 304, the AI/ML software 300 may typically include a plurality of AI/ML modules 306, wherein each AI/ML module 306 includes specific AI/ML model(s) configured to perform a particular task.

### Output Module

The output module 308 receives and implements the outputs of the AI/ML module. In some embodiments, the output module 308 may be a real-time notifier, a real-time executor, or a combination of a real-time notifier and a real-time executor. A real-time notifier is configured to send out real-time notifications, through various communication channels connected to the network 222, to an identified personnel group that is responsible for the monitoring and controlling of a given drilling operation. The real-time notifier may be configured to send notifications to the identified personnel group via one or more communication channels, which include but are not limited to electronic messaging channels (an example is the Microsoft Teams® software, which provides for electronic messaging between individuals in a specified channel, as well as videoconferencing capabilities), email, text messages, and may also include on-screen notifications provided through the user interface of the AI/ML software 300 and/or audio notifications broadcast through, for example, onsite communication devices 202 and offsite communication devices 204.

A real-time executor is configured to connect to the control system of the relevant drilling operation and adjust the parameters of the drilling system. In some embodiments, the parameters may be adjusted without any human intervention, which would occur for example in a fully automated system. In some embodiments, the suggested parameter adjustments may be confirmed by a human worker, prior to being implemented by the real-time executor, which would occur in a partially automated system.

The output module 308 may be configured to provide different types of outputs, depending on the specific task that is being performed by a specific AI/ML module 306. For example, some AI/ML modules 306 may be configured to generate commands for automating the control of specific drilling equipment, such as automatically controlling the chokes on a PMA, in which case the output module 308 may be configured to implement real-time execution of those control commands received from that AI/ML module. Another AI/ML module 306 may be configured to monitor specific equipment on the drilling rig and generate recommendations for the repair and maintenance of that equipment, in which case the output module 308 may be configured to send real-time notifications to an identified personnel group, so that human workers who receive the notification will take the appropriate actions by, for example, arranging for the maintenance or repair of the equipment identified by the AI/ML module.

To further illustrate the operation and principles of the methods and systems disclosed herein, three illustrative examples, not intended to be limiting, are provided below.

### Example 1: Overtrap Table Optimization

In an MPD operation, in order to hold an SBP during drill pipe connections (or at other times, when the rig pumps are off), the SBP is conventionally maintained by using an auxiliary pump to maintain flow through the chokes, thereby maintaining pressure in the system and avoiding pressure drops. Another conventional method is to operate the chokes manually and close them before the rig pumps are fully turned off, through on-site communication with the driller.

Using the systems and methods described herein, an innovative approach to maintaining SBP during a connection event is to employ an overshoot method, whereby it is predicted how much pressure will be lost when the anticipated rig pump shutdown occurs and then increase the target SBP to higher values before the anticipated rig pump shutdown. Then, when the rig pump turns off and pressure drops in the system, the SBP drops to the target SBP. This overshoot method advantageously reduces the costs, as a typical auxiliary pump may cost in the range of $50,000 to $100,000 USD, in addition to the costs for operating and maintaining the auxiliary pump. Additionally, eliminating the need for an auxiliary pump saves space on the rig and reduces the need to connect the auxiliary pump to the rig's power, piping, and other systems. As well, the overshoot method reduces operation time, as the operation of the auxiliary pump requires a human operator to monitor and operate the pump.

In an embodiment of the AI/ML software 300, the stream listener module 302 opens a stream listener 302a upon detecting that a drilling operation has started streaming data, for example via a data streaming platform. Once the stream listener 302a is open, the stream listener monitors the relevant real-time data stream for the drilling operation. The processing engine 304 is configured to extract and process the relevant data for monitoring a connection event from the data stream. The extracted and processed data is provided to the AI/ML module 306, and the AI/ML module 306 generates an overtrap table for maintaining the target SBP during the connection event.

The filters of the processing engine 304 include validating filters, which differentiate between the various scenarios that may occur during a connection event and accordingly employ different coping strategies. For example, a pop valve event may occur where standpipe pressure falls below the target SBP at which the current connection is aiming, before the choke is fully closed. In such a case, the connection may not meet the target SBP because of insufficient upstream pressure. Because this is an abnormal trap case, it will not normally produce a good trap result. Thus, the processing engine 304 recognizes a pop valve event as an anomalous event and the relevant data will not pass through the validating filters and will not update the AI/ML module 306 with the data from the pop valve event, as future suggested overtrap tables produced by the AI/ML module 306 would be erroneous for the next connection event. Thus, the filter of the processing engine 304, upon recognizing the pop valve event, will filter out the data relating to the pop valve event so that such data is not provided to update the AI/ML model of the AI/ML module 306.

However, the AI/ML module 306, upon detecting the pop valve event, will still analyze the data received from the processing engine 304 and identify that an anomalous event has occurred. Therefore, the data will not pass through the validating filters 304a into the AI/ML module 306. However, in some embodiments, upon detecting a pop valve event the processing engine 304 may issue a notification to the identified personnel group, alerting the human workers, describing the anomalous event and why the data from the detected anomalous event (i.e.: the pop valve event) could not pass through the validating filters 304a, so that appropriate action may be taken by the human workers who received the notification.

Additionally, the transformer 304b of the processing engine 304 transforms the raw, extracted data that passes through the filters, and formats the extracted data into a format that is accepted by the AI/ML model of the AI/ML module 306. Also, the plotter 304c of the processing engine 304 produces visual representations of the data relevant to the connection event and provides the visual representations to a user of the AI/ML software, for example via a dashboard. The visual representation may then be viewed by the human engineer, which is in an understandable format for the human engineer to monitor the quality of the connection that is occurring and identify any issues.

The AI/ML module 306 leverages machine learning models to optimize the parameters and provide the optimized trap table values accordingly. In some embodiments, ensemble methods, which are techniques that create multiple models and then combine them to produce improved results, may be applied in configuring and improving the AI/ML module 306. Additionally, bootstrap aggregation is used to reduce variance within a noisy dataset. As a result, a random subset of data in a training data set is created from the original dataset. The subset of the dataset includes all the parameters of the original dataset.

Boosting may also be applied, which is a sequential process, where each subsequent model attempts to correct the errors of the previous model. The subsequent models are dependent on the previous model. The boosting algorithm combines a number of weak AI/ML models to form a stronger AI/ML model.

A unique objective function describing the connection quality score is defined. The score is a function of two elements:

Connection quality score=f(Landing marker,Range marker)

### Where:

A landing marker is a mathematical expression that describes how well the landing surface back pressure matches the target pressure.

Range marker is a mathematical expression that describes the oscillation amplitude of the surface back pressure curve.

The goal is to obtain a high-quality score for each connection with a smooth surface back pressure curve and a good correlation between the landing SBP and the target SBP. With the relationships established between machine learning models and the drilling parameters, the quality score can be optimized. Depending on the use case, different optimization algorithms may be applied to search for optimized controllable parameters. Examples of optimization algorithms, not intended to be limiting, include:

Random search: Random samples from the solution space are evaluated. If the solution space is heavily sampled, this algorithm will approach the brute force solution and find a global optimum. The sampling method is important because it determines the samples evaluated.

Particle swarm optimization (PSO): This algorithm is a stochastic optimization technique modelled after the swarming or flocking of animals. PSO operates well in a multi-dimensional setting where at each iteration, the solution is tweaked toward the current best solution.

Bayesian optimization: This algorithm may be used to find optimal parameters of a “black box” function by sampling from a Gaussian process (GP). The tractable posterior distribution induced by the GP leads to efficient use of the information gathered by previous experiments, enabling optimal choices about what parameters to try next.

The feasibility of an algorithm to be used in controlling drilling operations in real-time on the accuracy of the algorithm in finding the global optimum. Runtime for algorithms is also important, since it directly relates to the amount of data to be processed and response lag. Too much lag time will result in a system that is not able to produce real-time control of the drilling operation. By utilizing a fast and accurate algorithm, a continuously updated model may be achieved which is based on the most recent data collected. As used herein, the use of the term “real-time” includes events or actions that occur with an insignificant amount of lag time between an event occurring on the drilling rig, the relevant drilling rig data entering the systems disclosed herein, and actions being taken by the system or human workers interacting with the system in order to control the drilling rig based on the real-time drilling rig data entering the system. For example, an insignificant amount of lag time may include a lag time measurable in a few seconds or milliseconds. As another example, an insignificant amount of lag time may include lag time equal to or less than five seconds or may be in the range between 0.4 and two seconds. As yet another example, an insignificant amount of lag time includes an amount of lag time that does not prevent the system or a human worker from implementing timely actions based on the real-time data being processed by the systems and methods disclosed herein.

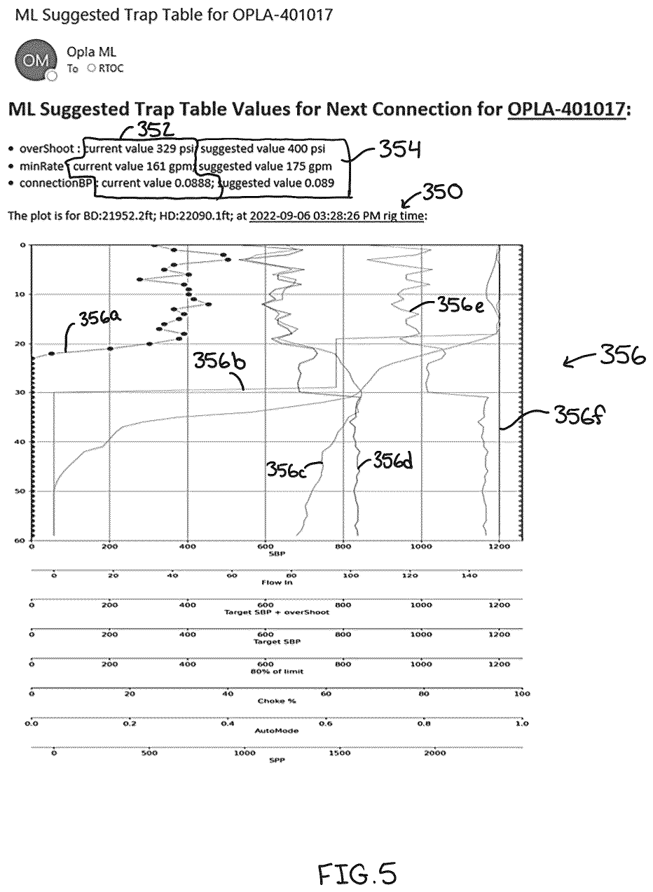

Once the AI/ML module 306 has generated the suggested trap table values for a given connection event, the AI/ML module communicates the suggested trap table values to the output module 308. in some embodiments, the output module 308 utilizes a real-time notifier to send notifications to an identified personnel group, the notification containing the suggested trap table values. An example of a notification, which may be sent to each person in the identified personnel group via email, an electronic messaging system, or any other electronic communication system, is provided in FIG. 5. The notification includes, in this example, the time of the connection event 350; the current connection settings 352 for the overshoot pressure, minimum rate and the choke speed parameter (ConnBP) and the suggested connection settings 354 for the overshoot pressure, minimum rate and the ConnBP, as determined by the AI/ML module 306. As well, the notification specifies the variance of the parameters relevant to the connection event over the connection window, provided in the notification as a connection plot 356. For example, data included on the connection plot 356 includes the percentage 356a by which the choke is closed; the flow in rate 356b; the SBP 356c; the target SBP 356d; the target SBP plus the overshoot pressure 356e; and 80% of the SBP limit 356f.

Additionally, the output module 308 may, in some embodiments, be configured to utilize a real-time executor, which connects to the control system 100 and adjusts the settings of each parameter without human intervention. The real-time executor generates a command, which is communicated to the on-site communication device 202. In some embodiments, the command, which in this instance may include instructions/commands to change the choke settings in a PMA, may be implemented via the PMA software 212 loaded onto the onsite device 202. The PMA software 212 communicates the command to the PMA control unit 170. Control unit 170 may utilize the motor drive module 176, in this instance, to actuate the choke motors on the PMA 122 to implement the suggested connection settings 354. Thus, maintaining the SBP by controlling the PMA 122 during a connection event, is fully automated in this embodiment.

### Example 2—Equipment Monitoring and Maintenance Prediction

The AI/ML methods and systems, disclosed herein, may be used to remotely monitor the operation of various equipment at a drilling site. Using AI/ML models trained on historic drilling data sets, data trends leading to the repair or maintenance of a given piece of equipment may be used to predict when similar equipment should be maintained for optimal performance, and when such equipment is performing sub-optimally and therefore requires repair or replacement before a breakdown occurs. Costly shutdowns of the drilling rig may thereby be avoided, by detecting when a piece of equipment needs to be repaired or replaced before it fails.

When an unexpected equipment breakdown occurs, the drilling rig operations may be halted for an indefinite period while the required parts are obtained, and the required repair personnel are transported to the site. Such delays may, in some circumstances, result in the rig being shutdown for a number of days, resulting in economic losses. Therefore, having the ability to predict that a piece of equipment will break down in a number of days or weeks unless it is repaired or replaced, allows for the operator to plan for the repair or replacement appropriately by arranging for the required parts, equipment and personnel to arrive at the site before the equipment failure occurs. This may result in a shorter shutdown period while the repair or replacement is performed, thereby mitigating the impacts of the equipment failure. Similarly, the AI/ML models may also determine an optimal maintenance schedule for the equipment, allowing for the equipment to operate under optimal conditions and potentially extending the useful life of the equipment.

In the present example, the monitoring and maintenance of bearing assemblies for the rotation control device (RCD) are described; however, it will be appreciated that any mechanical equipment, including but not limited to motors, valves, chokes, actuators, seals and other equipment or mechanical components at a drilling rig, may also be monitored and maintained in accordance with the methods and systems disclosed herein.

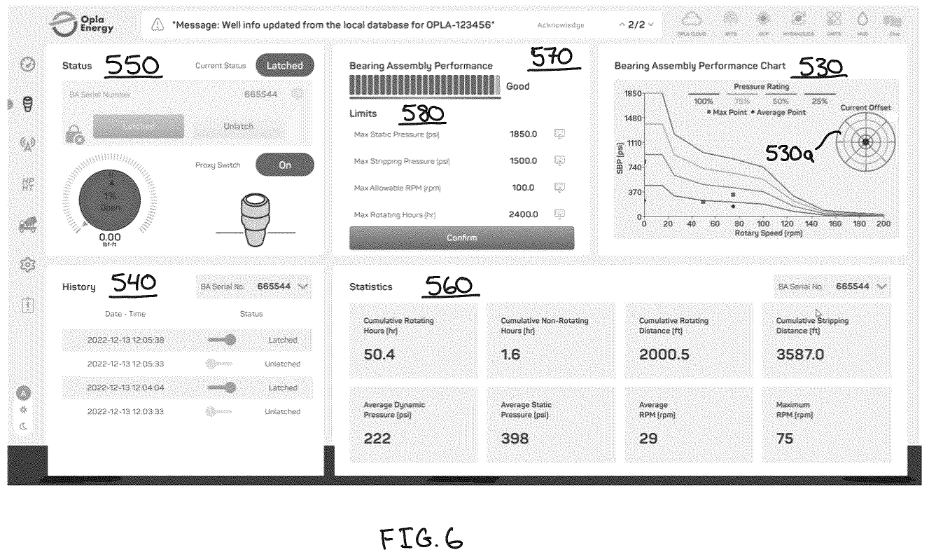

Taking the example of a bearing assembly, all of the bearing assemblies in an inventory are provided with a unique identifier, such as a serial number, and all data associated with the bearing assembly is tracked. Such data may include, but is not limited to, the bearing's working hours and work conditions, as illustrated in the dashboard shown in FIG. 6. As illustrated, data associated and tracked for a bearing assembly having serial number 665544 includes the operating statistics 560, tracking the cumulative rotating hours, cumulative non-rotating hours, cumulative rotating distance, cumulative stripping distance, average dynamic pressure, average static pressure, average RPM and maximum RPM. The dashboard may also include the limits for various bearing assembly parameters 580, including the maximum static pressure, maximum stripping pressure, maximum allowable RPM and maximum rotating hours. A status bar 550 indicates the current status of the bearing assembly (i.e.: whether it is latched to the bowl of the RCD for receiving the bearing assembly, or unlatched), and a history report 540 indicates the most recent status changes (i.e.: when the bearing assembly was most recently latched or unlatched). A bearing assembly performance chart 530 plots the rotary speed of the bearing against the SBP, with pressure rating markers indicating the rotary speed of the bearing against the SBP at the 100% pressure rating of the system, as well as at pressure ratings of 75%, 50% and 25%. This plot provides a ready visual indicator of the current status of the bearing; for example, where the plotted working points are below the 25% pressure rating marker, this indicates the bearing assembly easily handled the load and is in good operating condition. The bearing assembly performance chart 530 also includes a visual diagram 530a indicating the current offset of the bearing relative to the bowl of the RCD, so as to detect when the bearing assembly is offset and requires correction. The data associated with the bearing assembly is tracked and monitored in real-time via the AI/ML module 306.

The AI/ML module 306 includes one or more AI/ML models, each model trained on historical bearing assembly data sets for a plurality of other bearing assemblies operating under various conditions. The historical bearing assembly data also includes data on equipment maintenance, replacement and failure events for each bearing assembly. The AI/ML model is thus configured to learn and recognize data trends that leads up to equipment failing or requiring maintenance. The AI/ML model develops equations for relating the equipment failure, or maintenance requirements, to the working hours and conditions of the bearing assembly. When the AI/ML module, containing the trained AI/ML models, is deployed to monitor the real-time data streams of the plurality of bearing assemblies in the inventory of an operator, the AI/ML module may predict when the bearing assembly will require maintenance, repair or replacement before equipment failure occurs, so that the operator may arrange for the maintenance, repair or replacement and thereby mitigate equipment failure.

In addition to continually monitoring the real-time data of the inventory of bearing assemblies and notifying the operator when maintenance, repair or replacement is required, in some embodiments the AI/ML models may also be continually updated with the real-time data received from the operating bearing assemblies. In this manner, the AI/ML models may be improved over time, as new data sets are used to update the training of the models.

### Example 3—AI/ML for Anomaly Detection

There are trends in recorded drilling data that are associated with specific, anomalous events, which may require immediate attention and action. Historical data sets associated with MPD drilling projects, associated with specific anomalous events, may be used to train AI/ML models in order to identify trends in the data that lead to the historical, anomalous event occurring. As an illustrative example, in the Applicant's experience it is known that if a sudden increase in the measured SBP occurs at the same time that a Flow Out spike is detected, and the chokes on the PMA swing open, there is a high probability of fluid influx from the formation into the wellbore. If such a fluid influx event is detected early, it may be corrected by taking action. For example, depending on the amount of fluid that has entered the wellbore, the pumps are typically stopped, and the well is closed, in order to estimate the amount of influx fluid that has entered the wellbore and devise a solution to treat the problem. The engineered treatment plan is then implemented on the rig. Early detection of the probable fluid influx event may reduce the amount of time required to plan and execute the treatment plan and thereby correct the fluid influx event.

By training an AI/ML model on historical data sets in which fluid influx from the formation into the wellbore has occurred, the Applicant has found that the AI/ML model may then predict that such an event is about to occur by monitoring the real-time data on an MPD project. In addition, the model may similarly identify other data trends that also predict fluid influx into the wellbore is highly probable. In some embodiments, the AI/ML model may also be fine-tuned to predict the severity of a detected anomalous event thereby recommending an action that would best mitigate the detected anomalous event. Advantageously, in some embodiments, the AI/ML model is frequently or continuously updated as it monitors the real-time data and processes of multiple drilling sites, with the data sets of each drilling site being accessed by the AI/ML model via the network 222, which may be hosted on a cloud-based platform. In one aspect, the autonomous AI/ML model is able to adapt to data drifts, dynamic events and massive data sets.

What is claimed is:

1. An artificial intelligence and/or machine learning (AI/ML) system for monitoring and analyzing real-time drilling data to automate the control of a drilling rig, the drilling rig and the AI/ML system in communication with and controllable by a control system having a communication network, the communication network facilitating communication between and amongst at least an onsite device in communication with sensors and equipment of the drilling rig, an offsite device, and a server, the server hosting a data streaming platform for receiving real-time drilling data from the drilling rig via the onsite device, the server making the real-time data available via the network as a data stream, the AI/ML system comprising:
an AI/ML software program, the AI/ML software program hosted on at least one of the offsite device, the onsite device and the server, the AI/ML program comprising:
a stream listener module, the stream listener module for opening a stream listener of a plurality of stream listeners when the drilling rig commences operations, the stream listener for obtaining data relevant to a detected event from the data stream over the communication network;
the stream listener in communication with a processing engine, the processing engine for extracting and processing the relevant data obtained from the data stream, and generating extracted data from the data stream;
a machine learning (AI/ML) module in communication with the processing engine, the AI/ML module comprising at least one AI/ML model, the AI/ML model for analyzing the extracted data and generating an output, the output providing a command to modify the drilling rig system;
an output module in communication with the AI/ML module, the output module for enacting the outputting of the command received from the AI/ML module.

2. The system of claim 1, wherein the output module is a real-time notifier, and the command includes a real-time notification for alerting an identified personnel group of the detected event and the command to modify the drilling rig.

3. The system of claim 1, wherein the output module is a real-time executor, and the command includes real-time, automated implementation of a modified drilling parameter applied to the drilling rig.

4. A method for monitoring and analyzing real-time drilling data to automate a drilling rig system for drilling a well, the method comprising:
communicating, via a communication network, real-time data obtained from at least the drilling rig to a server so as to generate a data stream hosted on the server;
monitoring, via a stream listener of an AI/ML software program hosted on a device, the data stream so as to detect an event or condition;
processing, via a processing engine of the AI/ML software program, the real-time data relating to the detected event or condition to generate processed data, the processed data provided as an input to an AI/ML module;
generating, via the AI/ML module, an output, the output including a command to modify a drilling parameter of the drilling rig system based on an input of the processed data into the AI/ML module, the output provided to an output module of the AI/ML software program;
implementing, via the output module, the command to modify the drilling parameter of the drilling rig system.

5. The method of claim 4, wherein the processing step includes filtering the real-time data to extract data that is relevant to the detected event or condition to exclude data that is irrelevant to the detected event or condition from the extracted data.

6. The method of claim 4, wherein the method further includes a step of updating the AI/ML module with the processed data.

7. The method of claim 6, wherein the step of processing the data includes filtering the real-time data to identify data relating to an anomalous event and excluding the data relating to the anomalous event from the processed data that is used in the updating step to update the AI/ML module.

8. The method of claim 5, wherein the processing step includes generating a visual representation of the filtered data relevant to the detected event or condition and outputting the visual representation to at least one of an offsite device and an onsite device for a worker to monitor the event.

9. The method of claim 5, wherein the processing step includes transforming the extracted data into an accepted format for inputting the extracted data into the AI/ML module.

10. The method of claim 4, wherein the step of generating an output includes modifying the drilling parameter to optimize the drilling parameter.

11. The method of claim 4, wherein the detected event is a well kick, and the generated output command includes notifying an identified personnel group of the detected well kick and recommending modifications to the drilling parameters to mitigate the consequences of a blowout.

12. The method of claim 4, wherein the detected event is a drill pipe connection, and wherein the command to modify a drilling parameter of the drilling rig system includes generating an overtrap table, the overtrap table for increasing the surface back pressure (SBP) of the drilling rig system above a target SBP so that when the rig pump is turned off, the SBP will fall to the target SBP.

13. The method of claim 12, wherein the implementing step includes the output module sending a notification to an identified personnel group via the communication network, the notification advising the identified personnel group of the detected drill pipe connection and including the generated overtrap table to be implemented by one or more individuals in the identified personnel group.

14. The method of claim 12, wherein the implementing step includes the output module sending the command, via the communication network, to an onsite device, the onsite device to implement the parameters of the generated overtrap table via a controller of the drilling rig system.

15. The method of claim 14, wherein the drilling rig system includes a pressure management apparatus, and the controller is a pressure management apparatus controller.

16. The method of claim 4, wherein the event is a drilling anomaly and wherein the command generated by the AI/ML module includes a notification to be sent to an identified personnel group, alerting the identified personnel group of the drilling anomaly and providing a suggested action to mitigate the drilling anomaly.

17. The method of claim 16, wherein the drilling anomaly is an influx of fluid into the wellbore, and wherein the implementing step includes the output module sending the command, via the communication network, to an onsite device to stop a pump and close the well, via a controller of the drilling rig system, the controller in communication with the onsite device.

18. The method of claim 4, wherein the monitoring step includes monitoring a status of an equipment unit of the drilling rig system, and wherein detecting the event or condition includes detecting the equipment unit requires maintenance or repair, and wherein the implementing step includes sending a notification to an identified personnel group that the equipment unit requires maintenance or repair.

19. The method of claim 18, wherein the equipment unit comprises a plurality of equipment units monitored by a plurality of stream listeners to generate a processed data set, the processed data set containing data on the status of each equipment unit of the plurality of equipment units, and wherein the processed data set is input into the AI/ML module to generate an optimized maintenance schedule for each equipment unit of the plurality of equipment units.

20. The method of claim 19, wherein the processed data set is generated from real-time data obtained for the plurality of equipment units deployed across a plurality of drilling rig systems.
